(19) United States
(12) Patent Application Publication
(10) Pub. No.: US 2025/0138910 A1
(43) Pub. Date: May 1, 2025

(54) GENERATING AND USING CONTEXT BRIEFS TO IDENTIFY RELEVANT CHAT RESPONSES

(71) Applicant: Microsoft Technology Licenseing, LLC, Redmond, WA (US)

(72) Inventors: Swati Gulati, Union City, CA (US); Chujie He, Bellevue, WA (US); Chungheong Gooi, Redmond, WA (US); Joao Wagner Lima Cangussu, Woodinville, WA (US); Kelly John Banman, Vancouver (CA); Kyle Matthew Von Haden, Georgetown, TX (US); Noelle Renee Beaujon, New York, NY (US); Subash Chandran Canapathy, Redmond, WA (US); Justin Joseph Fagnan, Bellevue, WA (US)

(21) Appl. No.: 18/433,999

(22) Filed: Feb. 6, 2024

Related U.S. Application Data
(60) Provisional application No. 63/594,246, filed on Oct. 30, 2023.

(51) Int. Cl. G06F 9/54; G06F 40/35

(52) U.S. Cl. CPC G06F 9/541; G06F 40/35

(57) ABSTRACT

Methods, computer systems, and computer-storage media are provided for generating and using context briefs to identify relevant chat responses. In embodiments, a context template associated with an intent is obtained. The context template includes a data reference referencing dynamic data and content providing context for the dynamic data. Thereafter, a context brief associated with the intent is generated by obtaining the dynamic data and incorporating the dynamic data with the content. Upon obtaining an input data request indicating a user intent, the context brief is identified as corresponding with the user intent of the input data request based on the intent associated with the context brief. A prompt to be input into a large language model is generated. The prompt includes the input data request and the context brief. A response relevant to the input data request is obtained as output from the large language model.

### CROSS-REFERENCE TO RELATED APPLICATIONS

This application claims the benefit of U.S. Provisional Application No. 63/594,246, filed on Oct. 30, 2023, the entire contents are hereby incorporated herein their entirety.

### BACKGROUND

Large language models (LLMs) are generally used to perform various natural language processing (NLP) tasks. Oftentimes, LLMs are used to process structured data. For example, a user prompt may require processing of structured data that includes valuable information relevant to a user. Processing structured data via an LLM, however, can result in hallucinations as LLMs often fail to understand the structured nature of the data. In this regard, incorrect responses that are not grounded in reality or the input context may result. Further, LLMs may be unable to disambiguate contexts without additional information. To this end, structured data often relies on specific contexts, for instance, as the same term in a database could have different meanings in different contexts. Such a lack of understanding of inherent structure and ambiguity in context associated with structure data is exacerbated by extensive datasets and datasets with intricate relationships.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various aspects of the technology described herein are generally directed to systems, methods, and computer storage media for, among other things, facilitating generation and utilization of context briefs to identify relevant chat responses in an efficient and effective manner. Among other things, embodiments described herein efficiently and effectively provide information or responses in a comprehensive manner in accordance with structured data. To do so, relevant context, in the form of a context brief, is generated and included in a prompt to be input to an LLM such that the LLM can process structured data in association with relevant context, thereby enabling generation of a more relevant and tailored response. In particular, the context brief includes dynamic data, in the form of or representing structured data, that is incorporated, aggregated, or interleaved with content describing or providing context to the dynamic data. Accordingly, the content provided in the context brief provides context and an understanding of structured data. Further, the context brief can be generated using a context template that includes the content and data references used to obtain the dynamic data. In this regard, in accordance with generating a context brief using a context template, the data reference(s) in the context template is used to obtain dynamic data (e.g., structured data) that replaces or supplements the data reference. In this way, the dynamic data can be obtained from a data source such that it is the most up-to-date data being used in a prompt. As such, the context brief includes recent data as well as content to describe or provide context to the data. Using such a context brief enables the LLM to generate a response that is more suitable or relevant for a user, as structured data included in a prompt can be up-to-date, selected to provide a customized response, and provided with context.

### BRIEF DESCRIPTION OF DRAWINGS

The technology described herein is described in detail below with reference to the attached drawing figures, wherein:

FIG. 1 is a block diagram of an exemplary system for generating and using context briefs to identify relevant chat responses, suitable for use in implementing aspects of the technology described herein;

FIG. 2 is an example implementation for generating and using context briefs to identify relevant chat responses, via a chat service, in accordance with aspects of the technology described herein;

FIG. 3 provides an example process flow diagram for generating and using context briefs to identify relevant chat responses, in accordance with aspects of the technology described herein;

FIGS. 4A and 4B provide example context templates, in accordance with embodiments described herein;

FIG. 5A provides an example of a context brief, in accordance with aspects of the technology described herein;

FIG. 5B provides an example of a set of context briefs, in accordance with aspects of the technology described herein;

FIG. 6 provides an example method flow for generating and using context briefs to identify relevant chat responses, in accordance with aspects of the technology described herein;

FIG. 7 provides another example method flow for generating and using context briefs to identify relevant chat responses, in accordance with aspects of the technology described herein;

FIG. 8 provides another example method flow for generating and using context briefs to identify relevant chat responses, in accordance with embodiments described herein;

FIG. 9 is a block diagram of an exemplary computing environment suitable for use in implementing aspects of the technology described herein; and

FIG. 10 is a block diagram of an exemplary large language model environment suitable for use in implementing aspects of the technology described herein.

### DETAILED DESCRIPTION

The technology described herein is described with specificity to meet statutory requirements. However, the description itself is not intended to limit the scope of this patent. Rather, the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

### Overview

Large language models (LLMs) are generally used to perform various natural language processing (NLP) tasks. Oftentimes, LLMs are used to process structured data, which generally includes data that conforms to a data model. For example, a user prompt may require processing of structured data that includes valuable information relevant to a user. Using LLMs to process structured data, however, can result in hallucination, thereby increasing opportunities for incorrect responses that are not grounded in reality or the input context. In particular, LLMs often fail to understand the structured nature of data. Unlike traditional databases or structured data processing tools, LLMs often fail to comprehend tables, relationships, and/or schemas. Further, LLMs may be unable to disambiguate contexts without additional information. For instance, structured data often relies on specific contexts (e.g., the same term in a database could have different meanings in different contexts). Such a lack of understanding of inherent structure and an ambiguity in context is exacerbated by extensive datasets and datasets with intricate relationships. In this regard, LLMs may be less effective in providing a relevant or correct response when processing large and complex data structures across different sources and, in particular, without additional information providing context to the data.

As such, processing of structured data can result in incorrect and/or irrelevant responses being surfaced to a user. In this regard, to view a desired response, a user may need to continue searching for the desired information by generating and submitting new queries or requests to an LLM, thereby using computing resources to perform additional processing. As obtaining desired information may be time-consuming and burdensome, particularly when multiple search iterations are performed, computing and networking resources are unnecessarily consumed to facilitate the search for information. For instance, computer input/output (I/O) operations are unnecessarily multiplied in an effort to identify particular information. In this regard, an unnecessary quantity of prompts executed to find information can unnecessarily result in decreased throughput and increased network latency, thereby increasing usage of computing and network resources.

Accordingly, embodiments described herein are directed to generating and using context briefs to identify relevant chat responses in an efficient and effective manner. Among other things, embodiments described herein efficiently and effectively provide information or responses in a comprehensive manner in accordance with structured data. To do so, relevant context, in the form of a context brief, is included in a prompt to be input to an LLM such that the LLM can process structured data in association with relevant context, thereby enabling a more relevant and tailored response. In particular, the context brief includes dynamic data, which can be or represent structured data, that is incorporated, aggregated, or interleaved with content describing or providing context to the dynamic data. Further, as described herein, the context brief is generally generated using a context template that includes content and data references used to obtain the dynamic data. In this regard, in accordance with generating a context brief, the data reference(s) is used to obtain dynamic data that replaces or supplements the data reference. In this way, the dynamic data can be obtained from a data source such that it is generally up-to-date data. Accordingly, the context brief includes recent data as well as content to describe or provide context to the data. Using such a context brief enables the LLM to generate a response that is relatable or tailored to the user. In this way, a user can explore various information in a more efficient manner and, oftentimes, view responses that would otherwise not be returned via a conventional approach.

In operation, and depending on implementation, context briefs that integrate content and associated dynamic data are generated in association with various topics. In embodiments, a context brief is generated using a context template that includes the content and a data reference(s) used to obtain the dynamic data. In some cases, in generating context briefs from the template, the dynamic data replaces the data reference(s). Alternatively or additionally, the dynamic data is appended to the content and data reference(s). Advantageously, the context brief provides a prose-forward approach to communicating structured data. Further, the utilization of dynamic data enables more current or recent data to be access and used. For example, a context brief generated one week can have more up-to-date data than a context brief generated the previous week. As described herein, in some embodiments, context briefs are generated via offline processing. In this way, context briefs may be generated in a periodic manner or based on an occurrence of an event in an offline manner (e.g., generated in accordance with new data or data updates). In other embodiments, context briefs are generated in an online or dynamic manner. In this approach, context briefs are generated in real time in accordance with a data request.

In accordance with an input data request, a context brief(s) corresponding with the input data request is used to generate a prompt for inputting into an LLM. In this regard, a context brief that matches intent of the input data request is incorporated into a prompt that is provided as input into an LLM. As the prompt includes dynamic data relevant to, or of interest to, the user that input the data request, the LLM can generate a more desired response. Further, as the prompt includes context describing the dynamic data, the LLM can generate a more accurate or comprehensive response and is less likely to hallucinate, thereby resulting in more relevant or valuable responses presented to a user.

By way of example only, assume a set of organizational data is maintained at a data source. The organizational data may represent various facets of data pertaining to the organization, including employee productivity, financial data, etc. Now assume a user is interested in identifying employee productivity and inputs a data request indicating such an interest. Based on the input data request, embodiments of the technology described herein identify one or more context templates and/or context briefs relevant to the data request (e.g., based on user intent associated with the data request). In cases in which context templates are identified, corresponding context briefs can be generated therefrom in real time. As described, the context briefs include dynamic data and content describing or providing context to the dynamic data. Context briefs may include additional data such as actions suggested for incorporating in association with the data and/or content. A content brief(s) identified as relevant to the data request is used to generate a prompt. In this way, a prompt generated to input into an LLM includes the data request as well as the context brief having the dynamic data and corresponding content. The LLM can then use the dynamic data and corresponding content to facilitate a response that is relevant to the user's initial data request regarding employee productivity.

Advantageously, providing comprehensive and relevant responses to data requests in an efficient manner enables a user engaging in a search for information to more likely be presented with desired information without having to manually track down the desired data using various prompts and review of corresponding responses, thereby reducing utilization of computing resources. Further, using an LLM facilitates reducing computing resource consumption, such as computer memory and latency. In particular, responses can be accurately generated without requiring training and/or fine-tuning of a model to otherwise perform such functionality. Utilizing pre-trained models reduces computing resources consumed for performing training.

### Overview of Exemplary Environments for Generating and Using Context Briefs to Identify Relevant Chat Responses

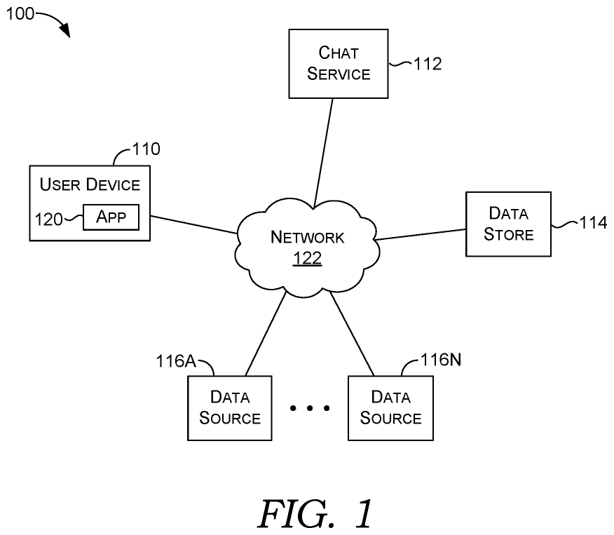

Referring initially to FIG. 1, a block diagram of an exemplary network environment 100 suitable for use in implementing embodiments described herein is shown. Generally, the system 100 illustrates an environment suitable for facilitating generation and utilization of context briefs to identify relevant chat responses. Among other things, embodiments described herein efficiently and effectively generate context briefs and, thereafter, use the context briefs to generate tailored responses to input data requests in a comprehensive manner. In particular, context briefs that integrate content and associated dynamic data are generated in association with various topics. A context brief generally provides context for a data request, such that additional information is included in the prompt for use in generating a response. In embodiments, a context brief is generated using a context template that includes the content and a data reference(s) used to obtain the dynamic data. In some cases, the dynamic data replaces the data references. Alternatively or additionally, the dynamic data is appended to the content and data references. Advantageously, the context brief provides a prose-forward approach to communicating structured data. In accordance with an input data request, a context brief(s) corresponding with an input data request is used to generate a model prompt for inputting into a large language model. In this regard, a context brief that matches intent of the input data request is incorporated into a model prompt that is provided as input into an LLM. As the model prompt includes dynamic data relevant to, or of interest to, the user that input the data request, the LLM can generate a more desired response. Further, as the model prompt includes context describing the dynamic data, the LLM can generate a more accurate or comprehensive response and is less likely to hallucinate, thereby resulting in more relevant or valuable responses presented to a user.

The network environment 100 includes a user device 110, a chat service 112, a data store 114, and data sources 116a-116n (referred to generally as data source(s) 116). The user device 110, the chat service 112, the data store 114, and the data sources 116a-116n can communicate through a network 122, which may include any number of networks such as, for example, a local area network (LAN), a wide area network (WAN), the Internet, a cellular network, a peer-to-peer (P2P) network, a mobile network, or a combination of networks. The data store 114 may store any type or amount of data, including data accessible to the user device 110, the chat service 112, and/or the data sources 116.

The network environment 100 shown in FIG. 1 is an example of one suitable network environment and is not intended to suggest any limitation as to the scope of use or functionality of embodiments disclosed throughout this document, and nor should the exemplary network environment 100 be interpreted as having any dependency or requirement related to any single component or combination of components illustrated therein. For example, the user device 110 and data sources 116a-116n may be in communication with the chat service 112 via a mobile network or the Internet, and the chat service 112 may be in communication with data store 114 via a local area network. Further, although the environment 100 is illustrated with a network, one or more of the components may directly communicate with one another, for example, via HDMI (High-Definition Multimedia Interface), and DVI (Digital Visual Interface). Alternatively, one or more components may be integrated with one another, for example, at least a portion of the chat service 112 and/or data store 114 may be integrated with the user device 110. For instance, a portion of the chat service 112 may be integrated with the user device (e.g., via application 120). By way of example only, a prompt manager may be integrated with the user device, while a context brief manager and a large language model are remote from the user device.

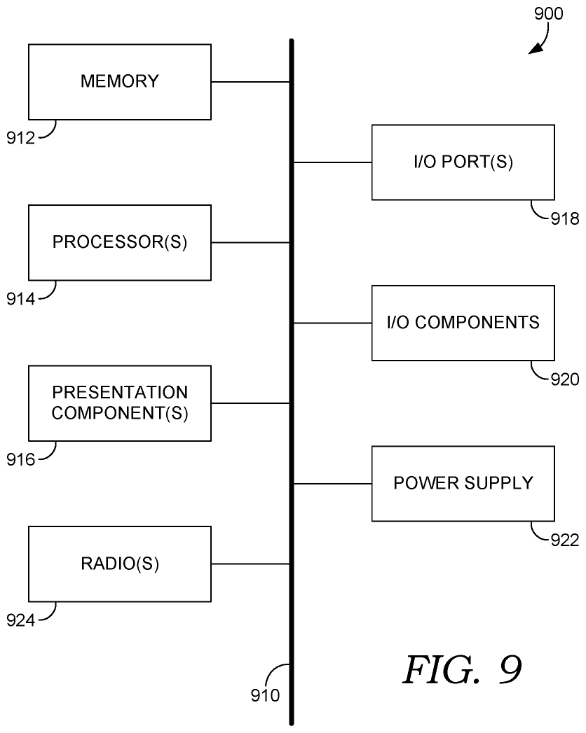

The user device 110 can be any kind of computing device capable of facilitating the generation and/or use of context briefs to identify relevant chat responses. For example, in an embodiment, the user device 110 can be a computing device such as computing device 900, as described above with reference to FIG. 9. In embodiments, the user device 110 can be a personal computer (PC), a laptop computer, a workstation, a mobile computing device, a PDA, a cell phone, or the like.

The user device can include one or more processors and one or more computer-readable media. The computer-readable media may include computer-readable instructions executable by one or more processors. The instructions may be embodied by one or more applications, such as application 120 shown in FIG. 1. The application(s) may generally be any application capable of facilitating the generation and/or use of context briefs to identify relevant chat responses. In embodiments, the application may be a chat application that includes functionality to initiate, obtain, and/or provide chat responses. In particular, a chat application may be used to input a data request and, in response, obtain a chat response. In other embodiments, the application may be an application that includes a chat functionality or tool. Such an application may be, for example, a document creating/editing application, an electronic communications application, a social networking application, a search application, a content management application (e.g., Microsoft Viva® that connects communication feedback, analytics, goals, and learning for employees and businesses), and/or the like. One example of a chat functionality or tool that is included in an application is Microsoft Copilot. In some implementations, the application(s) comprises a web application, which can run in a web browser, and could be hosted at least partially server-side (e.g., via chat service 112). In addition, or instead, the application(s) can comprise a dedicated application. In some cases, the application is integrated into the operating system (e.g., as a service).

User device 110 can be a client device on a client-side of operating environment 100, while chat service 112 can be on a server-side of operating environment 100. Chat service 112 may comprise server-side software designed to work in conjunction with client-side software on user device 110 so as to implement any combination of the features and functionalities discussed in the present disclosure. An example of such client-side software is application 120 on user device 110. This division of operating environment 100 is provided to illustrate one example of a suitable environment, and it is noted that there is no requirement for each implementation that any combination of user device 110 and/or chat service 112 remain as separate entities.

In an embodiment, the user device 110 is separate and distinct from the chat service 112, the data store 114, and the data sources 116 illustrated in FIG. 1. In another embodiment, the user device 110 is integrated with one or more illustrated components. For instance, the user device 110 may incorporate functionality described in relation to the chat service 112. For clarity of explanation, embodiments are described herein in which the user device 110, the chat service 112, the data store 114, and the data sources 116 are separate, while understanding that this may not be the case in various configurations contemplated.

As described, a user device, such as user device 110, can facilitate generating and/or using context briefs to identify relevant chat responses in an effective and efficient manner. Relevant chat responses generally include information that is tailored or more suitable to a user requesting a response. As such, relevant chat responses enable a user to more likely be presented with information desired by the user. For example, assume a user inputs a data request. Embodiments described herein enable an LLM to take into account relevant structured data and corresponding context provided in the prompt input to the LLM to generate a more comprehensive response to be provided to the user for viewing.

A user device 110, as described herein, is generally operated by an individual or entity interested in viewing information. In some cases, generation and/or utilization of a context brief(s) to identify relevant chat response(s) may be initiated at the user device 110. For instance, in some cases, a user may navigate to a chat interface or tool and input or select a data request. As one example, the data request may include or be a natural language query input by a user. Based on input or initiation of the data request, generation and/or utilization of a context brief(s) is initiated. For example, a user may navigate to a chat service, via the Internet, and input a data request to obtain responses relevant thereto. As another example, a user may open a content management service and input a data request in an input or chat box to obtain a corresponding chat response.

As described, the user device 110 can include any type of application and may be a stand-alone application, a mobile application, a web application, or the like. In some cases, the functionality described herein may be integrated directly with an application or may be an add-on, or plug-in, to an application. One example of an application that may be used to initiate generation and/or utilization of context briefs to identify relevant chat responses is Microsoft Viva®.

The user device 110 can communicate with the chat service 112 to initiate generation and/or utilization of context briefs to identify relevant chat responses. In embodiments, for example, a user may utilize the user device 110 to initiate generation and/or utilization of context briefs to identify relevant chat responses via the network 122. For instance, in some embodiments, the network 122 might be the Internet, and the user device 110 interacts with the chat service 112 to initiate generation and/or utilization of context briefs to identify relevant chat responses. In other embodiments, for example, the network 122 might be an enterprise network associated with an organization. In yet other embodiments, the chat service 112 may additionally or alternatively operate locally on the user device 110 to provide local responses. It should be apparent to those having skill in the relevant arts that any number of other implementation scenarios may be possible as well.

With continued reference to FIG. 1, the chat service 112 can be implemented as server systems, program modules, virtual machines, components of a server or servers, networks, and the like. At a high level, the chat service 112 manages artificial intelligence (AI) chat functionalities. A chat service generally refers to a service or engine that performs AI chat-related services. In particular, the chat service receives data requests and, in response, provides chat responses relevant to the data requests. In this regard, in association with obtaining a data request, the chat service 112 can identify relevant information and provide the information as a chat response for presentation in response to the data request. Such a chat service 112 may communicate with application 120 operating on user device 110 to provide back-end services to application 120. Alternatively or additionally, the chat service 112 can operate at the user device to provide local results. The chat response(s) may be presented to a user in any number of ways.

In accordance with embodiments described herein, the chat service 112 generates context briefs. In particular, context briefs that integrate content and associated dynamic data are generated in association with various topics. As such, upon obtaining a particular data request, a context brief corresponding with the related topic is selected for incorporation into a prompt for generating a response. In embodiments, a context brief is generated using a context template that includes the content and a data reference(s) used to obtain the dynamic data. In some cases, the dynamic data replaces the data references. Alternatively or additionally, the dynamic data is appended to the content and data references. In embodiments, dynamic data to include in the context brief can be determined using data accessed via data sources 116. In this way, data sources 116 can be accessed (e.g., as specified by data references in a context template) to obtain data to replace or supplement the data references). Data sources 116 may include various content or types of contents, such as web documents, images, videos, etc. In some cases, data sources 116 are associated with a content management system, such as Microsoft Viva®. Examples of data provided via data sources 116 include insights data, survey data, people data (e.g., data from Glint®), etc. Advantageously, the context brief provides a prose-focused approach for conveying structured data. In this way, an LLM can consume the data in a more effective and comprehensive manner.

In accordance with an input data request, a context brief(s) corresponding with an input data request is used to generate a prompt for inputting into a large language model. In this regard, a context brief that matches intent of the input data request is incorporated into a prompt that is provided as input into a large language model. As the prompt includes dynamic data relevant to, or of interest to, the user that input the data request, the LLM can generate a more desired response. Further, as the prompt includes context describing the dynamic data, the LLM can generate a more accurate or comprehensive response without hallucinating, thereby resulting in more relevant or valuable responses presented to a user.

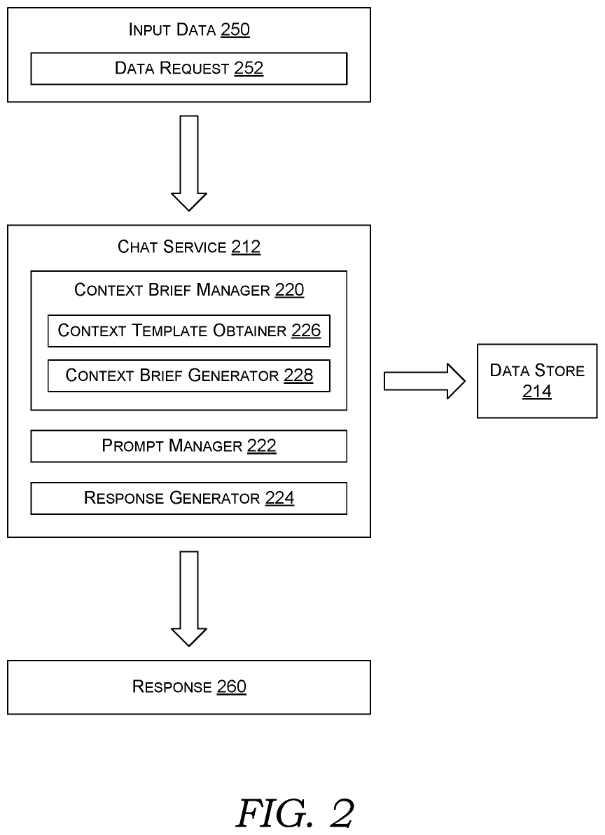

Turning now to FIG. 2, FIG. 2 illustrates an example implementation for generating and/or utilizing context briefs to identify relevant chat responses via chat service 212. The chat service 212 can communicate with the data store 214. The data store 214 is configured to store various types of information accessible by the chat service 212 or other server. In embodiments, data sources (such as data sources 116 of FIG. 1), user devices (such as user devices 110 of FIG. 1), and/or chat service (such as chat service 112 of FIG. 1) can provide data to the data store 214 for storage, which may be retrieved or referenced by any such component. As such, the data store 214 may store context templates, context briefs, user data, action data, content items, (e.g., documents, such as web documents, images, or the like), and/or the like.

In operation, the chat service 212 is generally configured to manage generating and/or using context briefs to identify relevant chat responses in an efficient and effective manner. In embodiments, the chat service 212 includes a context brief manager 220, a prompt manager 222, and a response generator 224. According to embodiments described herein, the chat service 212 can include any number of other components not illustrated. In some embodiments, one or more of the illustrated components 220, 222, and 224 can be integrated into a single component or can be divided into a number of different components. Components 220, 222, and 224 can be implemented on any number of machines and can be integrated, as desired, with any number of other functionalities or services.

The context brief manager 220 is generally configured to manage context briefs. In particular, the context brief manager 220 can generate context briefs that are used for identifying relevant chat responses. As described herein, a context brief generally refers to a set of data or information that includes context that may be relevant to a data request. In this way, the context brief is used to supplement a data request such that more relevant, personalized, and/or suitable content is provided in a response to the data request. Generally, the context brief includes information associated with a particular topic. In this way, a context brief(s) that corresponds with a topic of a data request can be selected to include in a prompt. In embodiments, the context brief includes dynamic data and context thereto, thereby providing more relevant or customized data for use by an LLM to generate a chat response.

In some cases, generation of a context brief is initiated based on a user input, such as input data 250. For example, assume a user provides a data request 252 (e.g., via a chat interface). In accordance with obtaining the data request 252, the context brief manager 220 may automatically generate a context brief(s). In generating context briefs in real time upon obtaining a data request, the particular context briefs to generate may be based on identifying user intent associated with the data request 250. For example, based on a user intent indicated in a data request, context templates corresponding with that user intent can be identified and used to generate context briefs.

In other cases, generation of context briefs is initiated based on an event. For instance, upon a lapse of a time duration, generation of context briefs may be automatically initiated. As one example, context briefs may be generated on a daily basis or weekly basis (e.g., in off-hours of high-volume processing). As another example, context brief generation may be initiated upon obtaining an updated set of data (e.g., in data sources) or a threshold amount of updated or new data. For example, as a threshold amount of data is added or modified within a data source, a trigger to generate context briefs may be initiated. In some cases, a context brief(s) may be generated for each context template. In other cases, a context brief(s) may be generated for context templates associated with the added or modified data.

In one embodiment, the context brief manager 220 includes a context template obtainer 226 and a context brief generator 228. According to embodiments described herein, the context brief manager 220 can include any number of other components not illustrated. In some embodiments, one or more of the illustrated components 226 and 228 can be integrated into a single component or can be divided into a number of different components.

The context template obtainer 226 is generally configured to obtain a context template from which to generate a context brief. A context template generally refers to a template that is used to create context briefs. A context template may include any type of context template attributes. Context template attributes refer to a type of data in a context template. A context template attribute may include, for example, a template identifier, template description, content, data references, actions, intents, and/or the like. A template identifier generally refers to an identifier that identifies a context template (e.g., a name, title, or other unique value). A template identifier may indicate a topic (e.g., either expressly or inherently) associated with the context template. A template description generally refers to a description that indicates subject matter associated with the template. The template description may be in the form of a summary or abstract, keywords, etc. Content generally refers to any type of content that provides context or information about a subject matter. Content may be manually authored, generated, or curated. In other cases, content is automatically obtained (e.g., via the Internet or organization documents). In some embodiments, the content includes research-based content, such as people science based research. A data reference refers to a reference to dynamic data. A data reference may be in any of a number of forms. In some cases, a data reference includes a pointer, a link, or other location indicator for the dynamic data. In other cases, a data reference includes a query. The query may be in the form of natural language and/or query parameters. The data reference may indicate metrics and corresponding aspects to obtain (e.g., by link or query). For instance, a metric identifier may be specified along with an aggregation type, a pivot(s), and/or a filter(s) to apply in order to obtain the desired data. In some cases, the data reference(s) may be interleaved in with the content. In this way, in cases in which the data reference is replaced with dynamic data, the dynamic data is surrounded or supported by natural language of the content to provide context to the dynamic data. In other cases, the data reference(s) may be separate from the content.

An action generally refers to an action suggestion for a user to take or initiate. In some cases, an action may be a list of potential actions depending on the particular dynamic data. An intent generally refers to an indication of an intent associated with the context template. Generally, the intent(s) is used to identify which context template is relevant to a data request (e.g., based on user intent identified in association with the data request). An intent can be represented in any of a number of ways. In some cases, intent is represented using keywords or phrases. In other cases, intent is represented using sample inputs (e.g., queries) that correspond with an intent, such that a similarity analysis between the data request and the sample inputs can be performed to identify relevance of the context template. As can be appreciated, any number and type of context template attributes can be included in a context template.

A context template can be obtained from any of a number of sources. For example, in some cases, context templates are generated and stored in data store 214 for reference by the context template obtainer 226. In some embodiments, context templates are specific to a user, an organization, a group, etc., such that the context templates are selectively applied and supportive for a particular entity.

As can be appreciated, context templates can be generated in any number of ways. In some cases, context templates are manually generated. For example, an individual associated with the chat service (e.g., developer, manager, etc.) may create various context templates for various topics. As another example, an individual associated with a content management service (e.g., Microsoft Viva®) may create various context templates based on content generated or used in association with the content management service. Alternatively or additionally, machine learning, such as use of an LLM, may be used to automatically generate context templates (e.g., via a prompt constructed specifically to generate context templates). As one example, a prompt may be constructed specifically to generate context templates and input into an LLM to obtain context templates as outputs. As another example, other machine learning techniques may be used to analyze various documents or content to generate context templates therefrom. As can be appreciated, in some cases, portions of a context template may be manually generated, while other portions are machine-generated. The technology used to generate context templates is not intended to be limited herein.

Context templates can be generated in different granularities, in relation to the types of template attributes to include (e.g., template identifier, template description, content, data references, etc.), and/or the extent of details (e.g., length of content). For example, in some cases, the content included in a context template may be specific and extensive, while in other cases the content included in a context template may be limited (e.g., a single paragraph or supported conclusion).

The context brief generator 228 is generally configured to generate a context brief. As described herein, a context brief generally refers to a set of data that includes dynamic data and content describing the dynamic data or the relevance thereof. Dynamic data generally refers to data that is or can change over time (e.g., as new or updated data is available). For example, dynamic data may include values associated with various metrics that vary over time. Although examples of dynamic data generally include numerical values, other representations of dynamic data include non-numerical text, images, etc. In embodiments, dynamic data includes structured data. Dynamic data can be generated or stored in association with various systems and/or data sources. As one example, dynamic data can be data obtained or stored in association with a content management system (e.g., Microsoft Viva®). For instance, insight data or observed data collected via Microsoft Viva® may be used as a source of dynamic data.

Generally, to generate a context brief, a context template is used. In particular, the obtained context template is used as a basis for the context brief, and the appropriate dynamic data is aggregated with the context template. To do so, the context template is analyzed to identify or reference the data references. The context brief generator 228 then uses the data references to obtain the dynamic data. As described, the data references may be in any of a number of forms. In some cases, a data reference includes a pointer, a link, or other location indicator for the dynamic data. In such a case, the context brief generator 228 may use the location indicator to access the dynamic data (e.g., via an application programming interface (API)), for example, from a data source such as data source 116 of FIG. 1. In other cases, a data reference includes a query (e.g., in the form of natural language and/or query parameters). In such a case, the data reference may be used as input into a search engine (e.g., a local search service, a network search service, or a web search service, among other things), data source, or data store. For example, a set of query parameters may be provided into a data source to obtain the desired dynamic data. The query parameters may include indications of desired metrics for which to obtain data, desired calculations to perform in association with the data, desired operations to perform to the data, and/or the like. As described, the data sources used to obtain the dynamic data may be of any type and any number. In one example, the data sources used correspond with the Microsoft Viva® application or service, such that the data sources collect employee data, organizational data, etc. As the employee and/or organizational data is modified, the data sources are updated such that the dynamic data included in the context brief is up-to-date with the most recent data collected.

As described, in some cases, the dynamic data is interleaved within the content, thereby providing a context to the dynamic data. For example, in cases in which the data references are interleaved with the content, the obtained dynamic data can replace or supplement the data reference within the content. Alternatively or additionally, the dynamic data can be separate from the content (e.g., within a particular portion of the context brief).

In some embodiments, the context brief generator 228 replaces or substitutes the data references with the corresponding dynamic data. Replacing or substituting the data references with the corresponding dynamic data, particularly when the data references are interleaved with the content, enables a natural language description or context for the dynamic data. Alternatively or additionally, the context brief generator 228 can supplement the data references. For example, an obtained dynamic data for a data reference can be added adjacent to (e.g., subsequent to) the data reference.

In addition to aggregating dynamic data, the context brief generator 226 may integrate additional data to generate a context brief. As one example, in some cases, the context brief generator 228 may generate or identify actions for integrating into the context brief. For instance, based on the content and/or dynamic data, one or more candidate actions relevant to the content and/or dynamic data may be identified. Such candidate actions may be identified via a search of information or selected from a predetermined set of candidate actions. For instance, a predetermined set of candidate actions may be associated with particular dynamic data, a particular intent, a particular context template, etc. In this way, for instance, the context brief generator 228 may access a set of candidate actions associated with a particular context template and select a subset of the candidate actions based on analysis of the dynamic data (e.g., when a threshold of data or particular data value is obtained, the candidate actions for the context brief can be selected).

As another example, in some cases, the context brief generator 228 may generate inferences based on data. For instance, based on the content and the dynamic data, the context brief generator 228 may generate inferences to include in the context brief. As one example, the context brief generator 228 may use machine learning, such as an LLM, to generate the inferences. For example, the content and dynamic data can be input into an LLM to perform reasoning of the data and generate an inference to include in the context brief.

As yet another example, in some cases, the context brief generator 228 can include user data in the context brief. User data generally refers to data pertaining to the user that provided the data request. User data included in the context brief may be any type of user data that can facilitate personalized or tailored chat responses. For example, a position or role in an organization associated with a user may be identified in the context brief. As another example, a demographic or geographic location associated with the user may be identified in the context brief. Other user data includes, for example, personal interests, formatting preferences, etc. In some cases, the particular dynamic data obtained may be associated with the user. For instance, data specific to the user, the user's organization, the user's role, etc., may be accessed as dynamic data (e.g., in accordance with a data reference).

The generated context briefs can be stored for subsequent utilization. For example, generated context briefs can be stored in a data store, such as data store 214. In this regard, context briefs generated in a periodic manner can be stored for subsequent reference and utilization (e.g., when a relevant data request is input by a user). Additionally or alternatively, generated context briefs may be provided to the prompt manager 222 for use in generating a prompt to input to an LLM. For instance, in association with obtaining a data request, a corresponding context brief can be generated by the context brief generator 228 and provided to the prompt manager 222 for incorporating into a prompt to be fed to an LLM.

In some cases, a generated context brief may be provided for display. For example, in instances in which context briefs are generated in a periodic manner, the generated context brief may be provided to a curator to obtain confirmation or approval for utilization of the context brief. As another example, in instances in which a context brief is generated in real time, the generated context brief may be provided to a user (e.g., via a user interface) to obtain confirmation or approval to incorporate into a prompt provided to an LLM.

Turning to the prompt generator 222, the prompt manager 222 is generally configured to generate a prompt to input into an LLM. As described herein, the prompt manager 222 generally aggregates an input data request (e.g., provided by a user) with a context brief(s) identified as relevant to the data request for processing by the LLM. In this regard, the prompt manager 222 preprocesses the data request to add relevant context to generate a more effective prompt, thereby obtaining a more comprehensive and customized response.

The prompt manager 222 is generally configured to generate prompts. As used herein, a prompt, or model prompt, generally refers to an input, such as a text input, that can be provided to a machine learning model (e.g., an LLM) to generate an output or response. In embodiments, a prompt generally includes text to influence a machine learning model, such as an LLM, to generate text having a desired content and structure. The prompt typically includes text given to a machine learning model to be completed. In this regard, a prompt generally includes a data request and, in some cases, context for use in generating desired output. A prompt may include any type of information. In accordance with embodiments described herein, a prompt includes a context brief, or a representation thereof. In some aspects, a prompt is generated to obtain, as output, a relevant response that is more tailored or customized for the user.

In embodiments, the prompt manager 222 is configured to select a set of one or more context briefs to include in the prompt. The particular context brief(s) to include in a prompt can be selected in any of a number of ways. In one implementation, the particular context brief(s) to include in a prompt is based on a context brief and/or context template that corresponds with, or matches, a user intent indicated in the data request. In this way, the prompt manager 222 can obtain a data request 252 as input. As described, the data request 252 may be input by a user (e.g., via a user interface) to a user device, which can then be provided to the prompt manager 222. The prompt manager 222 can analyze the data request to identify a context brief(s) and/or context template(s) corresponding with the user intent indicated in the data request.

In some cases, a particular user intent associated with the data request may be identified and, thereafter, used to identify a corresponding context template and/or context brief. User intent generally refers to a reason or goal of a user's query or request for information. In some cases, machine learning, such as natural language processing or an LLM, may be used to identify intent associated with the data request. Another example technology used to identify user intent is named-entity recognition (NER). NER is generally used to identify and classify named entities (e.g., in unstructured text) into predefined categories, such as names, organizations, locations, quantities, etc. In accordance with identifying user intent, the identified user intent can be compared to intents included in a context template and/or context brief to select a particular context template(s) and/or context brief(s) as relevant to the data request.

In other cases, to identify a context template and/or context brief relevant to a data request, the data request, or a portion thereof, can be compared to intents or other data included in context templates and/or context briefs to identify relevant templates and/or briefs. For example, the data request, or keywords thereof, may be compared to the intents (e.g., in the form of queries or keywords) included in a context template and/or context brief. If a level of similarity or matching is identified, the context template and/or context brief can be identified as relevant to the data request.

As can be appreciated, a context brief can be analyzed to identify whether it is relevant to a data request in instances in which the context brief was previously generated and stored (e.g., on a periodic basis). In implementations in which the context brief is generated in real time (e.g., in accordance with receiving a data request), a context template may be analyzed to identify whether it is relevant to a data request. For example, in accordance with receiving a data request, the set of context templates is accessed and analyzed to identify which of the context templates are relevant to the data request (e.g., based on an intent matching a user intent associated with the context template). Thereafter, a context brief(s) is generated in association with the context template identified as relevant to the data request. Alternatively, various context briefs can be generated in real time upon obtaining a data request and, thereafter, analyzed to identify or select context briefs for including in the prompt.

In some cases, context templates and/or context briefs may be ranked or scored. In this regard, the rankings or scores can be used to select a context template for incorporating into a prompt. Scores and/or ranks can be based on any type or number of attributes related to the context templates and/or briefs. As one example, scores or ranks can be based on similarity or an extent of matching of a context template or context brief to a user intent associated with the data request. As another example, scores or ranks can be based on user or administrative feedback indicating preferences or priorities for particular context templates or context briefs. As yet another example, scores or ranks can be based on depth or granularity of context templates or context briefs. For example, context templates and/or context briefs having more detailed content or more dynamic data may have a greater score or ranking than those with less content and/or dynamic data.

In some embodiments, the prompt manager 222 is configured to select context briefs, or portions thereof, in accordance with size requirements associated with an LLM. As one example, context briefs, or portions thereof, may be selected to be under a maximum number of tokens required by an LLM. For example, assume an LLM includes a 3,000-token limit. In such a case, a context brief(s), or portions thereof, totaling less than the 3,000-token limit may be selected. Such data selection may be based on, for example, recency of the data, such that a more recent context brief is selected. In other cases, context briefs may be selected based on scores or rankings (e.g., highest scores, equal distribution of scores, or other criteria associated with a score or weight). For instance, context briefs may be selected based on a corresponding score that is an indication of relevance to the data request, for example, according to user intent. As another example, portions of a context brief may be selected for the prompt in accordance with the token limit. For example, content with integrated dynamic data may be selected from the context brief for including in the prompt.

In some cases, the prompt manager 222 may incorporate additional data in the prompt. For example, in some cases, various data, such as actions and/or user data, may not be included in the context brief. In such cases, the prompt manager 222 may obtain or identify such data to include in the prompt. The data, such as action and/or user data, can be obtained as described above.

In addition to a prompt including the data request and a context brief(s), or a portion thereof, the prompt may also include output attributes. Output attributes generally indicate desired aspects associated with an output. For example, an output attribute may indicate a length of output. For instance, a prompt may include an instruction for a desired one-paragraph summary. As another example, an output attribute may indicate a target language for generating the output. For example, the input may be provided in one language, and an output attribute may indicate to generate the output in another language. Any other instructions indicating a desired output is contemplated within embodiments of the present technology.

The prompt manager 222 may format the data, such as the data request and the context brief, in various forms or data structures. One example of a data structure for a prompt is as follows:

```
{ Data Request - Input via the User
{ Context Brief 1:
  { Title
  { Desired Intents (e.g., Clarity, Adaptability, Belonging)
  { Body - Content A (e.g., data from web with references) interleaved
  with dynamic data A (e.g., Microsoft Viva ® metrics and insights) and
  set of actions A
{ Context Brief 2:
  { Title
  { Desired Intents (e.g., Clarity, Adaptability, Belonging)
  { Body - Content B (e.g., data from web with references) interleaved
  with dynamic data B (e.g., Microsoft Viva ® metrics and insights) and
  set of actions B
{ Output Attributes
```

As described, in embodiments, the prompt manager 222 generates or configures prompts in accordance with size constraints associated with a machine learning model. As such, the prompt manager 222 may be configured to detect the input size constraint of a model, such as an LLM or other machine learning model. Various models are constrained on a data input size they can ingest or process due to computational expenses associated with processing those inputs. For example, a maximum input size of 14,096 tokens (for DaVinci models) can be programmatically set. Other input sizes may not necessarily be based on token sequence length but other data size parameters, such as bytes. Tokens are pieces of words, individual sets of letters within words, spaces between words, and/or other natural language symbols or characters (e.g., %, $, !, etc.). Before a language model processes a natural language input, the input is broken down into tokens. These tokens are not typically parsed exactly where words start or end-tokens can include trailing spaces and even sub-words. Depending on the model used, in some embodiments, models can process up to 4,097 tokens shared between prompt and completion. Some models take the input, convert the input into a list of tokens, process the tokens, and convert the predicted tokens back to the words in the input. In some embodiments, the prompt manager 222 detects an input size constraint by simply implementing a function to call a routine that reads the input constraints.

The prompt manager 222 can determine which data is to be included in the model prompt. In some embodiments, the prompt manager 222 takes as input the input size constraint and the obtained data to determine what and how much data to include in the prompt. By way of example only, assume a prompt is being generated in relation to a data request. Based on the input size constraint, the prompt manager 222 can select which data, such as a data request and corresponding context briefs, to include in the prompt. As described, such a data selection may be based on any of a variety of aspects, such as date of data, weights of data, relevance of context briefs to the data request, and/or the like. As one example, the prompt manager 222 can first call for the input size constraint of tokens. Responsively, the prompt manager 222 can then tokenize each of the data, such as context brief data, to generate tokens, and, thereafter, responsively and progressively add each data ranked/weighted from highest to lowest if and until the token threshold (indicating the input size constraint) is met or exceeded, at which point the prompt manager 222 stops.

The response generator 224 is generally configured to generate responses to the generated prompt. In this regard, the response generator 224 utilizes a set of one or more context briefs, or portions or representations thereof, included in the prompt to facilitate generation of a response 260 that is relevant and tailored for the user. In embodiments, the response generator 224 can take, as input, a prompt or set of prompts generated by the prompt manager 222. Based on the prompt, the response generator 224 can generate a response 260 relevant to the data request 252 and a corresponding context brief(s) indicated in the prompt. In this regard, the LLM can reason over the prompt having the appropriate context for structured data and/or use statistical patterns and probabilities to generate text that is relevant to the prompt based on the appropriate context for the structured data.

Advantageously, as the response is generated based on data of a structured nature and corresponding context, the response is generally generated using language that provides an accurate reflection of the data. In this way, the context brief enables an LLM to reliably interpret structured data. As such, the response can have applicability to the desired information. Further, as the dynamic data included in the prompt is generally recent or up-to-date data, the response is generated in a more useful and customized manner for the user.

The response generator 224 may be or include any number of machine learning models or technologies. In some embodiments, the machine learning model is an LLM. A language model is a statistical and probabilistic tool that determines the probability of a given sequence of words occurring in a sentence (e.g., via next sentence prediction [NSP] or masked language model [MLM]). Simply put, it is a tool that is trained to predict the next word in a sentence. A language model is called a large language model when it is trained on an enormous amount of data. In particular, an LLM refers to a language model including a neural network with an extensive amount of parameters that is trained on an extensive quantity of unlabeled text using self-supervising learning. Oftentimes, LLMs have a parameter count in the billions, or higher. Some examples of LLMs are GOOGLE's BERT and OpenAI's GPT-2, GPT-3, and GPT-4. For instance, GPT-3 is a large language model with 175 billion parameters trained on 570 gigabytes of text. These models have capabilities ranging from writing a simple essay to generating complex computer codes-all with limited to no supervision. Accordingly, an LLM is a deep neural network that is very large (billions to hundreds of billions of parameters) and understands, processes, and produces human natural language by being trained on massive amounts of text. Although some examples provided herein include a single-mode generative model, other models, such as multimodal generative models, are contemplated within the scope of embodiments described herein. Generally, multimodal models are generated to make predictions based on different types of modalities (e.g., text and images).

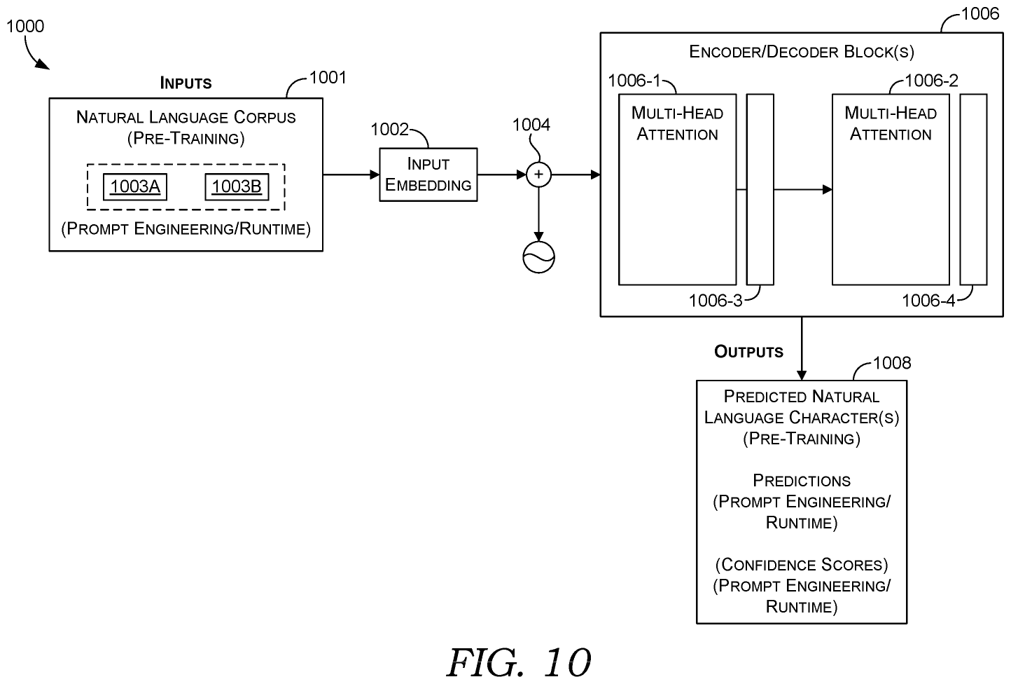

As such, as described herein, the response generator 224, in the form of an LLM, can obtain the prompt and, using such information in the prompt, generate a response or chat response relevant to the data request. In some embodiments, the response generator 224 takes on the form of an LLM, but various other machine learning models can additionally or alternatively be used. One example of a response generator in the form of an LLM is provided below in reference to FIG. 10.

The response 260 is provided as output for presentation to a user via a user device, such as user device 110 of FIG. 1. For example, based on an input data request indicating desired information, a response providing the desired information is displayed. The user interface for presenting the response can be designed in any number of ways and is not intended to be limited herein. In some cases, the context brief or set of context briefs used to generate the response can be presented, thereby providing the context to the user. Further, in some cases, the context brief may be editable. In this regard, in some cases, a new prompt can be generated in accordance with the edited or modified context brief. Thereafter, the response generator 224, or LLM, can execute the new prompt. Additionally or alternatively, the user feedback provided in relation to the context brief may be used to update the context brief for subsequent use (e.g., subsequent use by the user and/or other users) and/or used to update the context template for subsequent use (e.g., by the user and/or other users).

As discussed, various implementations and combinations of technologies may be used to implement various aspects related to generating and using context briefs to identify relevant chat responses. In some cases, the particular technologies employed may depend on the application utilizing such technologies.

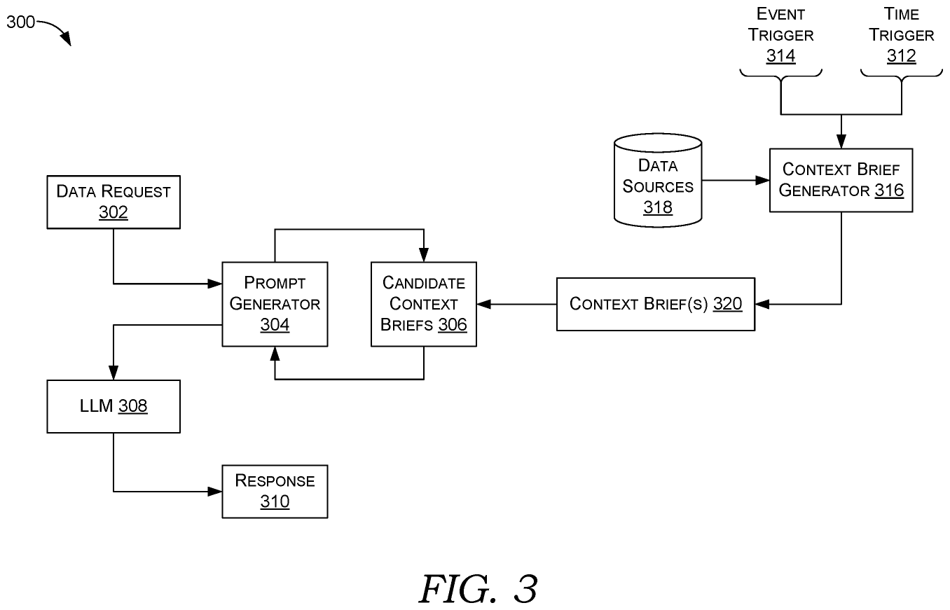

Turning to FIG. 3, FIG. 3 provides an example implementation 300 for generating and using context briefs to identify relevant chat responses. As shown, a data request 302 provided by a user is obtained at prompt generator 304. In response to the obtaining the data request 302, the prompt generator 304 accesses a set of candidate context briefs 306 to identify one or more context briefs to incorporate with the data request 302 to generate a prompt for inputting into LLM 308. In embodiments, the context brief(s) identified for incorporating into a prompt is based on matching the context brief to user intent associated with the data request 302. For example, user intent associated with the data request 302 may be identified and compared to various intents identified in association with the set of candidate context briefs 306. For the context briefs having an intent corresponding with or matching user intent associated with the data request 302, the prompt generator 304 generates a prompt that includes such context briefs along with the data request 302. In some cases, the context briefs are scored or ranked to select a particular context brief(s) to include in the prompt. Upon generating the prompt, the prompt generator 304 provides the prompt to the LLM 308 for processing. As one example, the LLM 308 takes as input the prompt and generates output, for instance, in the form of a summarization and/or synthesis. The response 310 is output from the LLM 308 and provided to the user device for viewing.

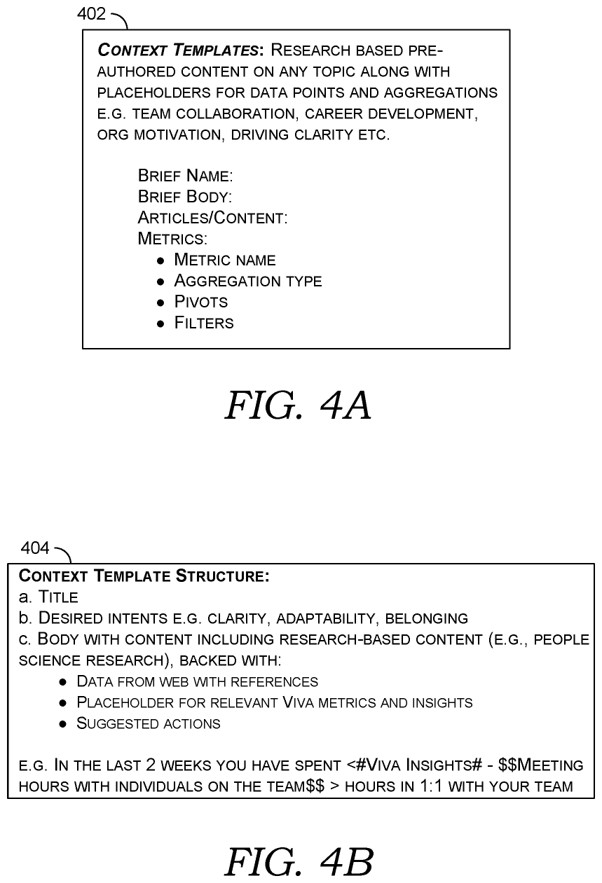

The set of candidate context briefs 306 for use in generating prompts can be obtained in a number of ways. In one example, as shown in FIG. 3, candidate brief(s) generation may be initiated based on a time trigger 312 and/or an event trigger 314. For instance, a time trigger 312 may be a lapse of a time that triggers context brief generator 316 to generate a context brief(s). An event trigger 314 may be an occurrence of an event that triggers context brief generator 316 to generate a context brief(s). An event may be, for example, an update of data, a data request, etc. In generating a context brief, the context brief generator 316 obtains a context template, for example, from data sources 318. The context template includes content and a data reference(s). FIG. 4A provides one example context template 402, and FIG. 4B provides another example context template 404. As shown, context templates may be generated or provided with any level of granularity.

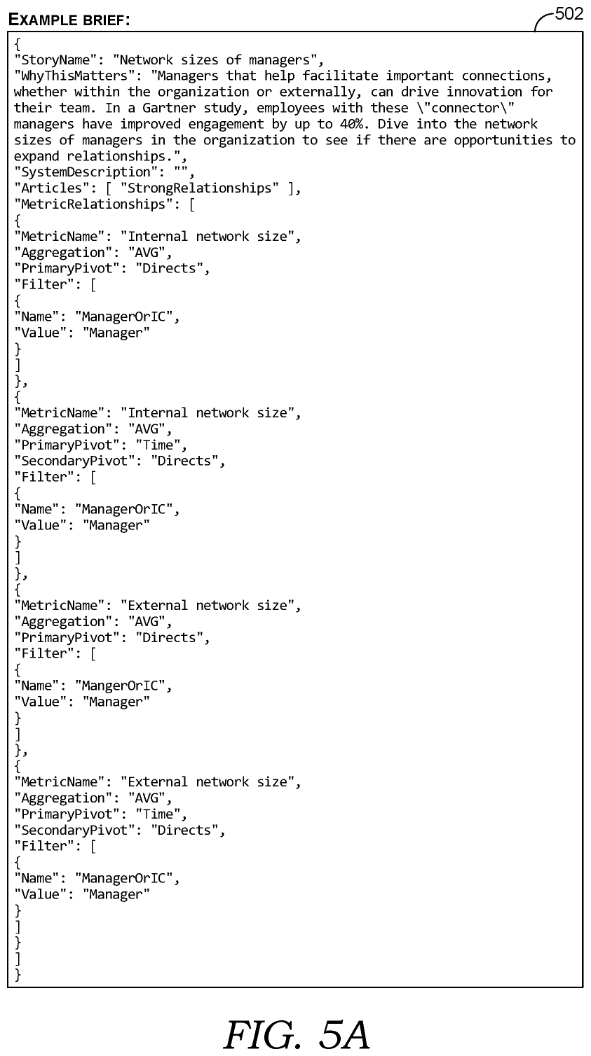

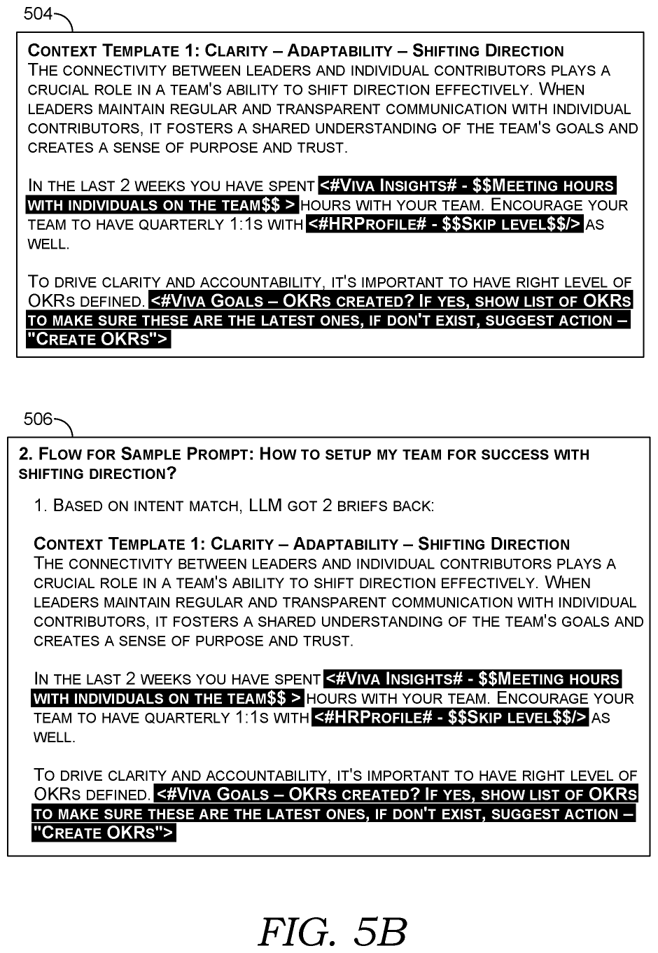

In accordance with obtaining a context template, the context brief generator 316 uses the data reference(s) to access dynamic data from data sources 318 and replaces or supplements the data reference(s) with the appropriate dynamic data to generate a context brief 320 that is provided to the set of candidate context briefs 306. FIG. 5A provides one example of a context brief 502. FIG. 5B provides an example of a set of context briefs 504 and 506. In this example, the context briefs correspond with an intent of shifting directions. In this regard, in cases in which a user intent associated with a data request pertains to shifting directions, both context brief 504 and 506 may be analyzed and considered for incorporating into a prompt. As described herein, the context brief generator 316 may generate the context brief 320 in real time (e.g., in accordance with obtaining data request 302). Alternatively, the context brief generator 316 may generate the context brief 320 in a pre-computed manner.

### Exemplary Implementations for Generating and Using Context Briefs to Identify Relevant Chat Responses

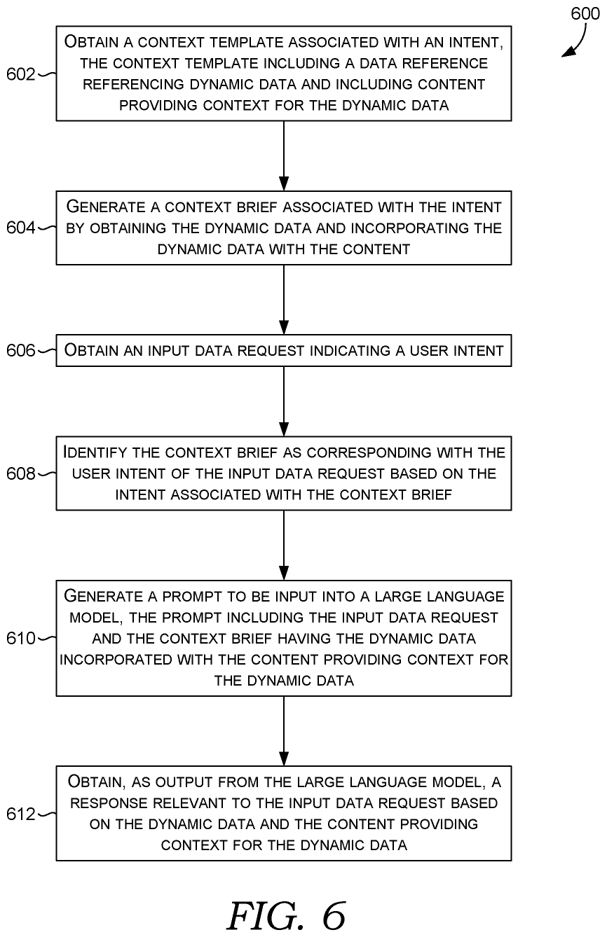

As described, various implementations can be used in accordance with embodiments described herein. FIGS. 6-8 provide methods of facilitating generation and use of context briefs to identify relevant chat responses, in accordance with embodiments described herein. The methods 600, 700, and 800 can be performed by a computer device, such as device 900 described below. The flow diagrams represented in FIGS. 6-8 are intended to be exemplary in nature and not limiting. For example, flow diagrams represented in FIGS. 6-8 represent various combinations of technologies and approaches used to manage generation and utilization of context briefs to identify relevant chat responses, but are not intended to reflect all combinations of technologies and approaches that may be used in accordance with embodiments described herein.

With respect to FIG. 6, FIG. 6 provides an example method flow 600 for generating and using context briefs to identify relevant responses, in accordance with embodiments described herein. At block 602, a context template associated with an intent is obtained. In embodiments, the context template includes a data reference referencing dynamic data and content providing context for the dynamic data. The data reference may be or include a query, a set of query parameters, a link to a data location, an indication of an API call, and/or the like. The data reference may also indicate an operation to perform in association with the dynamic data (e.g., a mathematical operation, a filter or pivot, etc.). In some cases, the dynamic data is structured data, for example, stored in association with a remote data store or data source. At block 604, a context brief associated with the intent is generated by obtaining the dynamic data and incorporating the dynamic data with the content. Dynamic data can be obtained using the data reference. For example, the data reference can be used to initiate an API call to obtain desired data. In some cases, the context brief can be generated by replacing the data reference with the dynamic data to interleave the dynamic data within the content. In other cases, the dynamic data supplements the data reference. Generation of a context brief can be based on expiration (e.g., on a daily basis) or a time duration of an occurrence of an event. A context brief may include additional data, such as an action, which may be recommended based on the dynamic data and/or the content. At block 606, an input data request indicating a user intent is obtained. At block 608, the context brief is identified as corresponding with the user intent of the input data request based on the intent associated with the context brief. At block 610, a prompt to be input into a large language model is generated. In embodiments, the prompt includes the input data request and the context brief having the dynamic data incorporated with the content providing context for the dynamic data. At block 612, a response relevant to the input data request based on the dynamic data and the content providing context for the dynamic data is obtained as output from the large language model.

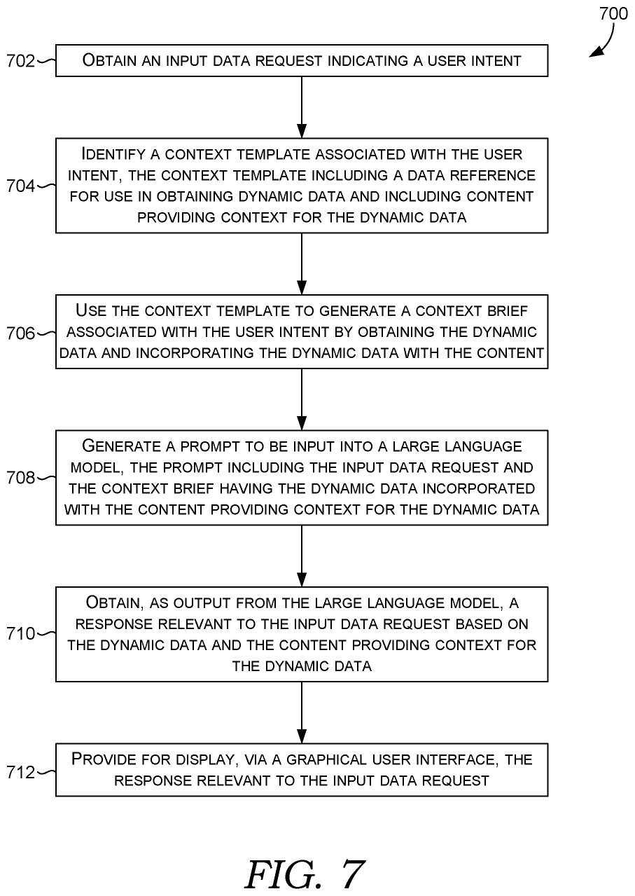

Turning to FIG. 7, FIG. 7 provides another example method flow 700 for generating and using context briefs to identify relevant chat responses, in accordance with embodiments described herein. Initially, at block 702, an input data request indicating a user intent is obtained. The input data request may be provided, via a user interface, to request information from a chat service that generates responses using an LLM. At block 704, a context template associated with the user intent is identified. In embodiments, the context template includes a data reference for use in obtaining dynamic data and including content providing context for the dynamic data. The context template may be identified as associated with the user intent, for example, based on an extent of similarity or matching between the user intent of the input data request with an intent included in the context template. In some cases, to do so, the context template can be identified by analyzing a set of stored context templates to identify which of the stored context templates match the user intent of the input data request. The context templates may include content of various subject matters or topics. In some implementations, the context templates include content related to organizational data.

At block 706, the context template is used to generate a context brief associated with the user intent by obtaining the dynamic data and incorporating the dynamic data with the content. In some cases, dynamic data is obtained using the data reference to execute an API call or a query. To generate the context brief, the dynamic data can replace the data reference to interleave the dynamic data within the content. The context brief may include any additional type of data, such as an action recommended to be performed. At block 708, a prompt to be input into a large language model is generated. In embodiments, the prompt includes the input data request and the context brief having the dynamic data incorporated with the content providing context for the dynamic data. At block 710, a response relevant to the input data request based on the dynamic data and the content providing context for the dynamic data is obtained as output from the large language model. At block 712, the response relevant to the input data request is provided for display via a graphical user interface.

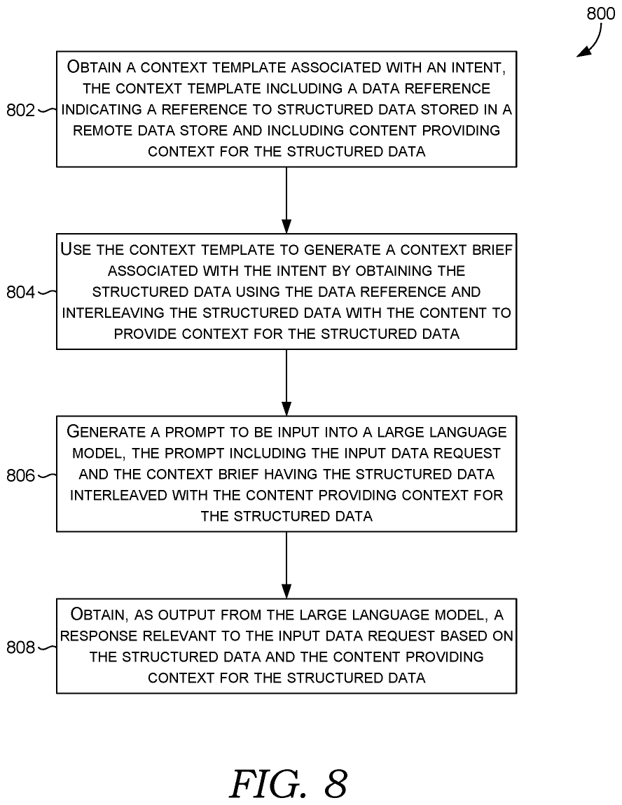

Turning to FIG. 8, FIG. 8 provides an example method flow 800 for generating and using context briefs to identify relevant chat responses, in accordance with embodiments described herein. Initially, at block 802, a context template associated with an intent is obtained. In embodiments, the context template includes a data reference indicating a reference to structured data stored in a remote data store and includes content providing context for the structured data. The context template may be obtained from a data store that stores a set of pregenerated context templates. At block 804, the context template is used to generate a context brief associated with the intent by obtaining the structured data using the data reference and interleaving the structured data with the content to provide context for the structured data. In some cases, the context brief is generated in response to obtaining an input data request associated with a user intent that matches the intent associated with the context template. In other cases, the context brief is generated based on an expiration of a time duration. The structured data can be obtained in any number of ways, including using the data reference to execute an API call or a query. At block 806, a prompt to be input into a large language model is generated. The prompt includes the input data request and the context brief having the structured data interleaved with the content providing context for the structured data. In embodiments, the prompt is generated in response to obtaining an input data request. In some cases, the context brief included in the prompt can be selected, from among a set of context briefs stored in a data store, based on the intent associated with the context brief matching a user intent associated with the input data request. At block 808, a response relevant to the input data request based on the structured data and the content providing context for the structured data is obtained as output from the large language model.

Accordingly, various aspects of technology are directed to systems, methods, and graphical user interfaces for intelligently generating and using context briefs to identify relevant chat responses. It is understood that various features, subcombinations, and modifications of the embodiments described herein are of utility and may be employed in other embodiments without reference to other features or subcombinations. Moreover, the order and sequences of steps shown in the example methods 600, 700, and 800 are not meant to limit the scope of the present disclosure in any way, and in fact, the steps may occur in a variety of different sequences within embodiments hereof. Such variations and combinations thereof are also contemplated to be within the scope of embodiments of this disclosure.

In some embodiments, a computing system is provided. The computing system can include a processor and computer storage memory having computer-executable instructions stored thereon that, when executed by the processor, configure the computing system to perform operations. In embodiments, the operations include obtaining a context template associated with an intent, the context template including a data reference referencing dynamic data and including content providing context for the dynamic data. The operations further include generating a context brief associated with the intent by obtaining the dynamic data and incorporating the dynamic data with the content. The operations further include obtaining an input data request indicating a user intent. The operations also include identifying the context brief as corresponding with the user intent of the input data request based on the intent associated with the context brief. The operations also include generating a prompt to be input into a large language model, the prompt including the input data request and the context brief having the dynamic data incorporated with the content providing context for the dynamic data. The operations further include obtaining, as output from the large language model, a response relevant to the input data request based on the dynamic data and the content providing context for the dynamic data. Advantageously, the context brief provides a prose-forward approach to communicating structured data, thereby enabling a more accurate and tailored response.

In any combination of the above embodiments of the computing system, the data reference includes a query, a set of query parameters, a link to a data location, or an indication of an application programming interface (API) call.

In any combination of the above embodiments of the computing system, the dynamic data comprises structured data.

In any combination of the above embodiments of the computing system, the dynamic data is obtained from a remote data source using the data reference.

In any combination of the above embodiments of the computing system, the context brief is generated by replacing the data reference with the dynamic data to interleave the dynamic data within the content.

In any combination of the above embodiments of the computing system, the context brief includes an action recommended based on the dynamic data and the content.

In any combination of the above embodiments of the computing system, the data reference indicates an operation to perform in association with the dynamic data.

In any combination of the above embodiments of the computing system, the context brief is generated based on expiration of a time duration or an occurrence of an event.

In other embodiments, a computer-implemented method is provided. The method includes obtaining an input data request indicating a user intent. The method also includes identifying a context template associated with the user intent, the context template including a data reference for use in obtaining dynamic data and including content providing context for the dynamic data. The method also includes using the context template to generate a context brief associated with the user intent by obtaining the dynamic data and incorporating the dynamic data with the content. The method further includes generating a prompt to be input into a large language model, the prompt including the input data request and the context brief having the dynamic data incorporated with the content providing context for the dynamic data. The method further includes obtaining, as output from the large language model, a response relevant to the input data request based on the dynamic data and the content providing context for the dynamic data, and causing display, via a graphical user interface, of the response relevant to the input data request. Advantageously, the context brief provides a prose-forward approach to communicating structured data, thereby enabling a more accurate and tailored response.

In any combination of the above embodiments of the computer-implemented method, the input data request provided, via a user interface, to request information from a chat service that generates responses using the large language model.

In any combination of the above embodiments of the computer-implemented method, the context template is identified as associated with the user intent based on an extent of similarity or matching between the user intent of the input data request with an intent included in the context template.

In any combination of the above embodiments of the computer-implemented method, the dynamic data is obtained using the data reference to execute an application programming interface (API) call or a query.

In any combination of the above embodiments of the computer-implemented method, the context brief is generated by substituting the data reference with the dynamic data to interleave the dynamic data within the content.

In any combination of the above embodiments of the computer-implemented method, the context brief includes an action recommended to be performed.

In any combination of the above embodiments of the computer-implemented method, the context template is identified by analyzing a plurality of stored context templates, wherein the stored context templates include corresponding content associated with organizational data.

In other embodiments, one or more computer storage media having computer-executable instructions embodied thereon that, when executed by one or more processors, cause the one or more processors to perform a method is provided. The method includes obtaining a context template associated with an intent, the context template including a data reference indicating a reference to structured data stored in a remote data store and including content providing context for the structured data. The method also includes using the context template to generate a context brief associated with the intent by obtaining the structured data using the data reference and interleaving the structured data with the content to provide context for the structured data. The method also includes generating a prompt to be input into a large language model, the prompt including the input data request and the context brief having the structured data interleaved with the content providing context for the structured data. The method further includes obtaining, as output from the large language model, a response relevant to the input data request based on the structured data and the content providing context for the structured data. Advantageously, the context brief provides a prose-forward approach to communicating structured data, thereby enabling a more accurate and tailored response.

In any combination of the above embodiments of the media, wherein the prompt is generated in response to obtaining an input data request, and wherein the context brief included in the prompt is selected, from among a set of context briefs stored in a data store, based on the intent associated with the context brief matching a user intent associated with the input data request.

In any combination of the above embodiments of the media, the context brief is generated in response to obtaining an input data request associated with a user intent that matches the intent associated with the context template.

In any combination of the above embodiments of the media, the structured data is obtained using the data reference to execute an application programming interface (API) call or a query.

In any combination of the above embodiments of the media, the context brief is generated based on an expiration of a time duration.

### Overview of Exemplary Operating Environments

Having briefly described an overview of aspects of the technology described herein, an exemplary operating environment in which aspects of the technology described herein may be implemented is described below in order to provide a general context for various aspects of the technology described herein.

Referring to the drawings in general, and to FIG. 9 in particular, an exemplary operating environment for implementing aspects of the technology described herein is shown and designated generally as computing device 900. Computing device 900 is just one example of a suitable computing environment and is not intended to suggest any limitation as to the scope of use or functionality of the technology described herein, and nor should the computing device 900 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 9, computing device 900 includes a bus 910 that directly or indirectly couples the following devices: memory 912, one or more processors 914, one or more presentation components 916, input/output (I/O) ports 918, I/O components 920, an illustrative power supply 922, and a radio(s) 924. Bus 910 represents what may be one or more buses (such as an address bus, data bus, or combination thereof). Although the various blocks of FIG. 9 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The diagram of FIG. 9 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 9 and refer to “computer” or “computing device.”

Computing device 900 typically includes a variety of computer-readable media. Computer-readable media can be any available media that can be accessed by computing device 900 and includes both volatile and non-volatile, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVDs) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 912 includes computer storage media in the form of volatile and/or non-volatile memory. The memory 912 may be removable, non-removable, or a combination thereof. Exemplary memory includes solid-state memory, hard drives, and optical-disc drives. Computing device 900 includes one or more processors 914 that read data from various entities such as bus 910, memory 912, or I/O components 920. Presentation component(s) 916 present data indications to a user or other device. Exemplary presentation components 916 include a display device, speaker, printing component, and vibrating component. I/O port(s) 918 allow computing device 900 to be logically coupled to other devices including I/O components 920, some of which may be built-in.

Illustrative I/O components include a microphone, joystick, game pad, satellite dish, scanner, printer, display device, wireless device, a controller (such as a keyboard and a mouse), a natural user interface (NUI) (such as touch interaction, pen [or stylus] gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 914 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 900. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 900. The computing device 900 may be equipped with depth cameras, such as stereoscopic camera systems, infrared camera systems, RGB camera systems, and combinations of these, for gesture detection and recognition. Additionally, the computing device 900 may be equipped with accelerometers or gyroscopes that enable detection of motion. The output of the accelerometers or gyroscopes may be provided to the display of the computing device 900 to render immersive augmented reality or virtual reality.

A computing device may include radio(s) 924. The radio 924 transmits and receives radio communications. The computing device may be a wireless terminal adapted to receive communications and media over various wireless networks. Computing device 900 may communicate via wireless protocols, such as code-division multiple access (“CDMA”), Global System for Mobiles (“GSM”), or time-division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi®connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

Turning to FIG. 10, FIG. 10 is a block diagram of a language model 1000 (for example, a BERT model or Generative Pre-trained Transformer [GPT]-4 model) that uses particular inputs to make particular predictions (for example, answers to questions), according to some embodiments. In one embodiment, the language model 1000 corresponds to the response generator 224 of FIG. 2 described herein. In various embodiments, the language model 1000 includes one or more encoders and/or decoder blocks 1006 (or any transformer or portion thereof).

First, a natural language corpus (for example, various WIKIPEDIA English words or BooksCorpus) of the inputs 1001 are converted into tokens and then feature vectors and embedded into an input embedding 1002 to derive meaning of individual natural language words (for example, English semantics) during pre-training. In some embodiments, to understand English language, corpus documents, such as text books, periodicals, blogs, social media feeds, and the like are ingested by the language model 1000.

In some embodiments, each word or character in the input(s) 1001 is mapped into the input embedding 1002 in parallel or at the same time, unlike existing long short-term memory (LSTM) models, for example. The input embedding 1002 maps a word to a feature vector representing the word. But the same word (for example, “apple”) in different sentences may have different meanings (for example, brand versus fruit). This is why a positional encoder 1004 can be implemented. A positional encoder 1004 is a vector that gives context to words (for example, “apple”) based on a position of a word in a sentence. For example, with respect to a message “I just sent the document,” because “I” is at the beginning of a sentence, embodiments can indicate a position in an embedding closer to “just,” as opposed to “document.” Some embodiments use a sine/cosine function to generate the positional encoder vector using the following two example equations:

$${PE}_{( pos , 2 i )} = sin ( pos / {10000}^{2 i / {d}_{model}} ) \qquad ( 1 )$$

$${PE}_{( pos , 2 i + 1 )} = cos ( pos / {10000}^{2 i / {d}_{model}} ) . \qquad ( 2 )$$

After passing the input(s) 1001 through the input embedding 1002 and applying the positional encoder 1004, the output is a word embedding feature vector, which encodes positional information or context based on the positional encoder 1004. These word embedding feature vectors are then passed to the encoder and/or decoder block(s) 1006, where it goes through a multi-head attention layer 1006-1 and a feedforward layer 1006-2. The multi-head attention layer 1006-1 is generally responsible for focusing or processing certain parts of the feature vectors representing specific portions of the input(s) 1001 by generating attention vectors. For example, in Question-Answering systems, the multi-head attention layer 1006-1 determines how relevant the i^{th} word (or particular word in a sentence) is for answering the question or relevant to other words in the same or other blocks, the output of which is an attention vector. For every word, some embodiments generate an attention vector, which captures contextual relationships between other words in the same sentence or other sequences of characters. For a given word, some embodiments compute a weighted average or otherwise aggregate attention vectors of other words that contain the given word (for example, other words in the same line or block) to compute a final attention vector.

In some embodiments, a single-headed attention has abstract vectors Q, K, and V that extract different components of a particular word. These are used to compute the attention vectors for every word, using the following equation (3):

$$Z = softmax ( \frac{Q \cdot {K}^{T}}{\sqrt{Dimension of vector Q , K or V}} ) \cdot V . \qquad ( 3 )$$

For multi-headed attention, there are multiple weight matrices W^{q}, W^{k}, and W^{v} so there are multiple attention vectors Z for every word. However, a neural network may expect one attention vector per word. Accordingly, another weighted matrix, W^{z}, is used to make sure the output is still an attention vector per word. In some embodiments, after the layers 1006-1 and 1006-2, there is some form of normalization (for example, batch normalization and/or layer normalization) performed to smoothen out the loss surface, making it easier to optimize while using larger learning rates.

Layers 1006-3 and 1006-4 represent residual connection and/or normalization layers where normalization recenters and rescales or normalizes the data across the feature dimensions. The feedforward layer 1006-2 is a feed-forward neural network that is applied to every one of the attention vectors outputted by the multi-head attention layer 1006-1. The feedforward layer 1006-2 transforms the attention vectors into a form that can be processed by the next encoder block or make a prediction at 1008. For example, given that a document includes first natural language sequence “the due date is . . . ,” the encoder/decoder block(s) 1006 predicts that the next natural language sequence will be a specific date or particular words based on past documents that include language identical or similar to the first natural language sequence.

In some embodiments, the encoder/decoder block(s) 1006 includes pre-training to learn language (pre-training) and make corresponding predictions. In some embodiments, there is no fine-tuning because some embodiments perform prompt engineering or learning. Pre-training is performed to understand language, and fine-tuning is performed to learn a specific task, such as learning an answer to a set of questions (in Question-Answering [QA] systems).

In some embodiments, the encoder/decoder block(s) 1006 learns what language and context for a word is in pre-training by training on two unsupervised tasks (Masked Language Model [MLM] and Next Sentence Prediction [NSP]) simultaneously or at the same time. In terms of the inputs and outputs, at pre-training, the natural language corpus of the inputs 1001 may be various historical documents, such as text books, journals, and periodicals, in order to output the predicted natural language characters in 1008 (not make the predictions at runtime or prompt engineering at this point). The example encoder/decoder block(s) 1006 takes in a sentence, paragraph, or sequence (for example, included in the input [s] 1001), with random words being replaced with masks. The goal is to output the value or meaning of the masked tokens. For example, if a line reads, “please [MASK] this document promptly,” the prediction for the “mask” value is “send.” This helps the encoder/decoder block(s) 1006 understand the bidirectional context in a sentence, paragraph, or line at a document. In the case of NSP, the encoder/decoder block(s) 1006 takes, as input, two or more elements, such as sentences, lines, or paragraphs, and determines, for example, if a second sentence in a document actually follows (for example, is directly below) a first sentence in the document. This helps the encoder/decoder block(s) 1006 understand the context across all the elements of a document, not just within a single element. Using both of these together, the encoder/decoder block(s) 1006 derives a good understanding of natural language.

In some embodiments, during pre-training, the input to the encoder/decoder block(s) 1006 is a set (for example, two) of masked sentences (sentences for which there are one or more masks), which could alternatively be partial strings or paragraphs. In some embodiments, each word is represented as a token, and some of the tokens are masked. Each token is then converted into a word embedding (for example, 1002). At the output side is the binary output for the next sentence prediction. For example, this component may output 1, for example, if masked sentence 2 followed (for example, was directly beneath) masked sentence 1. The outputs are word feature vectors that correspond to the outputs for the machine learning model functionality. Thus, the number of word feature vectors that are input is the same number of word feature vectors that are output.

In some embodiments, the initial embedding (for example, the input embedding 1002) is constructed from three vectors: the token embeddings, the segment or context-question embeddings, and the position embeddings. In some embodiments, the following functionality occurs in the pre-training phase. The token embeddings are the pre-trained embeddings. The segment embeddings are the sentence numbers (that includes the input [s] 1001) that is encoded into a vector (for example, first sentence, second sentence, and so forth, assuming a top-down and right-to-left approach). The position embeddings are vectors that represent the position of a particular word in such a sentence that can be produced by positional encoder 1004. When these three embeddings are added or concatenated together, an embedding vector is generated that is used as input into the encoder/decoder block(s) 1006. The segment and position embeddings are used for temporal ordering since all of the vectors are fed into the encoder/decoder block(s) 1006 simultaneously, and language models need some sort of order preserved.

In pre-training, the output is typically a binary value C (for NSP) and various word vectors (for MLM). With training, a loss (for example, cross-entropy loss) is minimized. In some embodiments, all the feature vectors are of the same size and are generated simultaneously. As such, each word vector can be passed to a fully connected layered output with the same number of neurons equal to the same number of tokens in the vocabulary.

In some embodiments, after pre-training is performed, the encoder/decoder block(s) 1006 performs prompt engineering or fine-tuning on a variety of QA data sets by converting different QA formats into a unified sequence-to-sequence format. For example, some embodiments perform the QA task by adding a new question-answering head or encoder/decoder block, just the way a masked language model head is added (in pre-training) for performing an MLM task, except that the task is a part of prompt engineering or fine-tuning. This includes the encoder/decoder block(s) 1006 processing the inputs 1003A and/or 1003B in order to make the predictions and generate a prompt response, as indicated in 1004. Prompt engineering, in some embodiments, is the process of crafting and optimizing text prompts for language models to achieve desired outputs. In other words, prompt engineering comprises a process of mapping prompts (for example, a question) to the output (for example, an answer) that it belongs to for training. For example, if a user asks a model to generate a poem about a person fishing on a lake, the expectation is it will generate a different poem each time. Users may then label the output or answers from best to worst. Such labels are an input to the model to make sure the model is giving more human-like or best answers, while trying to minimize the worst answers (for example, via reinforcement learning). In some embodiments, a “prompt” as described herein includes one or more of: a request (for example, a question or instruction [for example, “write a poem”]), target content, and one or more examples, as described herein.

The technology described herein has been described in relation to particular aspects, which are intended in all respects to be illustrative rather than restrictive.

What is claimed is:

1. A computing system comprising:
a processor; and
computer storage memory having computer-executable instructions stored thereon that, when executed by the processor, configure the computing system to perform operations comprising:
obtaining a context template associated with an intent, the context template including a data reference referencing dynamic data and including content providing context for the dynamic data;
generating a context brief associated with the intent by obtaining the dynamic data and incorporating the dynamic data with the content;
obtaining an input data request indicating a user intent;
identifying the context brief as corresponding with the user intent of the input data request based on the intent associated with the context brief;
generating a prompt to be input into a large language model, the prompt including the input data request and the context brief having the dynamic data incorporated with the content providing context for the dynamic data; and
obtaining, as output from the large language model, a response relevant to the input data request based on the dynamic data and the content providing context for the dynamic data.

2. The computing system of claim 1, wherein the data reference includes a query, a set of query parameters, a link to a data location, or an indication of an application programming interface (API) call.

3. The computing system of claim 1, wherein the dynamic data comprises structured data.

4. The computing system of claim 1, wherein the dynamic data is obtained from a remote data source using the data reference.

5. The computing system of claim 1, wherein the context brief is generated by replacing the data reference with the dynamic data to interleave the dynamic data within the content.

6. The computing system of claim 1, wherein the context brief includes an action recommended based on the dynamic data and the content.

7. The computing system of claim 1, wherein the data reference indicates an operation to perform in association with the dynamic data.

8. The computing system of claim 1, wherein the context brief is generated based on expiration of a time duration or an occurrence of an event.

9. A computer-implemented method comprising:
obtaining an input data request indicating a user intent;
identifying a context template associated with the user intent, the context template including a data reference for use in obtaining dynamic data and including content providing context for the dynamic data;
using the context template to generate a context brief associated with the user intent by obtaining the dynamic data and incorporating the dynamic data with the content;
generating a prompt to be input into a large language model, the prompt including the input data request and the context brief having the dynamic data incorporated with the content providing context for the dynamic data;
obtaining, as output from the large language model, a response relevant to the input data request based on the dynamic data and the content providing context for the dynamic data; and
causing display, via a graphical user interface, of the response relevant to the input data request.

10. The computer-implemented method of claim 9, the input data request provided, via a user interface, to request information from a chat service that generates responses using the large language model.

11. The computer-implemented method of claim 9, wherein the context template is identified as associated with the user intent based on an extent of similarity or matching between the user intent of the input data request with an intent included in the context template.

12. The computer-implemented method of claim 9, wherein the dynamic data is obtained using the data reference to execute an application programming interface (API) call or a query.

13. The computer-implemented method of claim 9, wherein the context brief is generated by substituting the data reference with the dynamic data to interleave the dynamic data within the content.

14. The computer-implemented method of claim 9, wherein the context brief includes an action recommended to be performed.

15. The computer-implemented method of claim 9, wherein the context template is identified by analyzing a plurality of stored context templates, wherein the stored context templates include a corresponding content associated with organizational data.

16. One or more computer storage media having computer-executable instructions embodied thereon that, when executed by one or more processors, cause the one or more processors to perform a method, the method comprising:
obtaining a context template associated with an intent, the context template including a data reference indicating a reference to structured data stored in a remote data store and including content providing context for the structured data;
using the context template to generate a context brief associated with the intent by obtaining the structured data using the data reference and interleaving the structured data with the content to provide context for the structured data;
generating a prompt to be input into a large language model, the prompt including the input data request and the context brief having the structured data interleaved with the content providing context for the structured data; and
obtaining, as output from the large language model, a response relevant to the input data request based on the structured data and the content providing context for the structured data.

17. The media of claim 16, wherein the prompt is generated in response to obtaining an input data request, and wherein the context brief included in the prompt is selected, from among a set of context briefs stored in a data store, based on the intent associated with the context brief matching a user intent associated with the input data request.

18. The media of claim 16, wherein the context brief is generated in response to obtaining an input data request associated with a user intent that matches the intent associated with the context template.

19. The media of claim 16, wherein the structured data is obtained using the data reference to execute an application programming interface (API) call or a query.

20. The media of claim 16, wherein the context brief is generated based on an expiration of a time duration.
